(19) United States
(12) Patent Application Publication
(10) Pub. No.: US 2016/0206929 A1
(43) Pub. Date: Jul. 21, 2016

(54) SYSTEM AND METHOD FOR PRODUCING BALLS IN THE ABSENCE OF INFLATION

(71) Applicant: Eternal Prowess Enterprise Co., Ltd., Tainan City (TW)

(72) Inventors: Shao Ting YUAN, Tainan City (TW); Frank I Teh CHANG, Kowloon (HK)

(73) Assignee: Eternal Prowess Enterprise Co., Ltd., Tainan City (TW)

(21) Appl. No.: 15/002,015

(22) Filed: Jan. 20, 2016

Related U.S. Application Data
(60) Provisional application No. 62/105,635, filed on Jan. 20, 2015.

(51) Int. Cl. A63B 39/00; B29C 65/02; B29C 43/02; B29C 43/52; B29C 45/00; B29C 45/72

(52) U.S. Cl. CPC A63B 39/00; B29C 45/0055; B29C 45/7207; B29C 43/021; B29C 43/52; B29C 65/02; B29C 2043/023; B29K 2105/251

(57) ABSTRACT

The system and method of the present disclosure produces balls that conform in performance and dimensions or dimension range to inflated balls. In an exemplary embodiment of the present disclosure, the balls have a weight that is within a standard weight range of an inflated ball. In another exemplary embodiment of the present disclosure, the balls have a bounce characteristic that is within a standard bounce range of an inflated ball. In yet another exemplary embodiment of the present disclosure, the balls are tuned to achieve an audible response or sound characteristic that is similar to that of an equivalent inflated ball. It should be understood that an exemplary embodiment ball in accordance with the present disclosure can include any combination of features, or all features, including weight, dimensions, bounce, and sound or audible response when bounced.

### TECHNICAL FIELD

This disclosure relates to a system and method for producing balls, such as a soccer ball, a basketball, a football, etc., without the use of a compressed gas to inflate the ball for use.

### BACKGROUND

Many types of inflated balls exist, including soccer balls, basketballs, footballs (including American, Association, Australian rules, Gaelic, Rugby, Rugby League, and Rugby Union), dodge balls, and volley balls. One common characteristics of these balls is that they require a source of pressurized air for initial and subsequent inflation.

### SUMMARY

This disclosure provides a method of forming a ball, comprising forming a first blocker and a second blocker. Each of the first blocker and the second blocker is configured to have a first density. The method further includes heating each one of the first blocker and the second blocker, and compressing each one of the heated first blocker and the heated second blocker to increase the density of each one of the heated first blocker and the heated second blocker to a second density greater than the first density. The method further includes adhering the first blocker to the second blocker to form the ball.

This disclosure also provides a method of forming a ball, comprising forming a first plurality of blockers, each blocker of the first plurality of blockers is configured to have a first density. The method includes heating each one the first plurality of blockers, and then compressing each one of the first plurality of heated blockers to increase the density of each one of the first plurality of heated blockers to a second density greater than the first density. The method further includes adhering each one of the first plurality of blockers to each other to form a first half of the ball.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 shows a cross-sectional view of a processing apparatus in accordance with an exemplary embodiment of the present disclosure.

FIG. 2 shows a perspective view of a ball hemisphere formed in the processing apparatus of FIG. 1, in accordance with an exemplary embodiment of the present disclosure.

FIG. 3 shows a cross-sectional view of a compression apparatus with the ball hemisphere of FIG. 2 positioned in a compression chamber, in accordance with an exemplary embodiment of the present disclosure.

FIG. 4 shows a perspective view of the ball hemisphere after processing in the compression apparatus of FIG. 3, in accordance with an exemplary embodiment of the present disclosure.

FIG. 5 shows a pair of ball hemispheres glued together in accordance with an exemplary embodiment of the present disclosure, along with a decorative panel that can optionally be applied to a portion of the ball hemispheres.

FIG. 6 shows a cross sectional view of a ball hemisphere in accordance with another exemplary embodiment of the present disclosure.

FIG. 7 shows a bottom view of an interior portion of a ball hemisphere in accordance with an exemplary embodiment of the present disclosure.

### DETAILED DESCRIPTION

While inflatable balls serve their intended purpose well, one challenge with such balls is initially inflating the ball, and then maintaining inflation at a desirable pressure. Equipment required to inflate such a ball includes at least a pressure sensor, a device to overcome an integral pressure valve, such device often described as a needle, and a source of pressurized gas or air. It should be understood that inflated balls are used in most places inhabited by humans. One challenge with such balls is maintaining inflation. In some locations, a suitable air pump may be unavailable. In some instances, an appropriate interface with an inflatable ball, such as a needle, may be unavailable. Even in places that typically have air pumps readily available, such may be unavailable in specific locations, such as a remote field, because the weight of the air pump made such unsuitable to carry to some locations, or because an air pump did not appear to be needed, until the remote location was reached.

Even when air pumps are available, there can be uncertainty as to the amount of pressure required for proper inflation. In addition, periodic calibration of air pressure gauges is necessary to prevent erroneous pressure measurements. Furthermore, keeping a properly calibrated pressure gauge and proper inflation pressure ranges handy presents an additional burden for formal or informal game playing using inflated balls.

The system and method of the present disclosure produces balls that conform in performance and dimensions or dimension range(s) to inflated balls. In an exemplary embodiment of the present disclosure, the disclosed balls have a weight that is within a standard weight range of an inflated ball. In another exemplary embodiment of the present disclosure, the disclosed balls have a bounce characteristic that is within a standard bounce range of an inflated ball. In yet another exemplary embodiment of the present disclosure, the disclosed balls are tuned to achieve an audible response or sound characteristic that is similar to that of an equivalent inflated ball. It should be understood that an exemplary embodiment ball in accordance with the present disclosure can include any combination of features, or all features, including weight, dimensions, bounce, and sound or audible response when bounced.

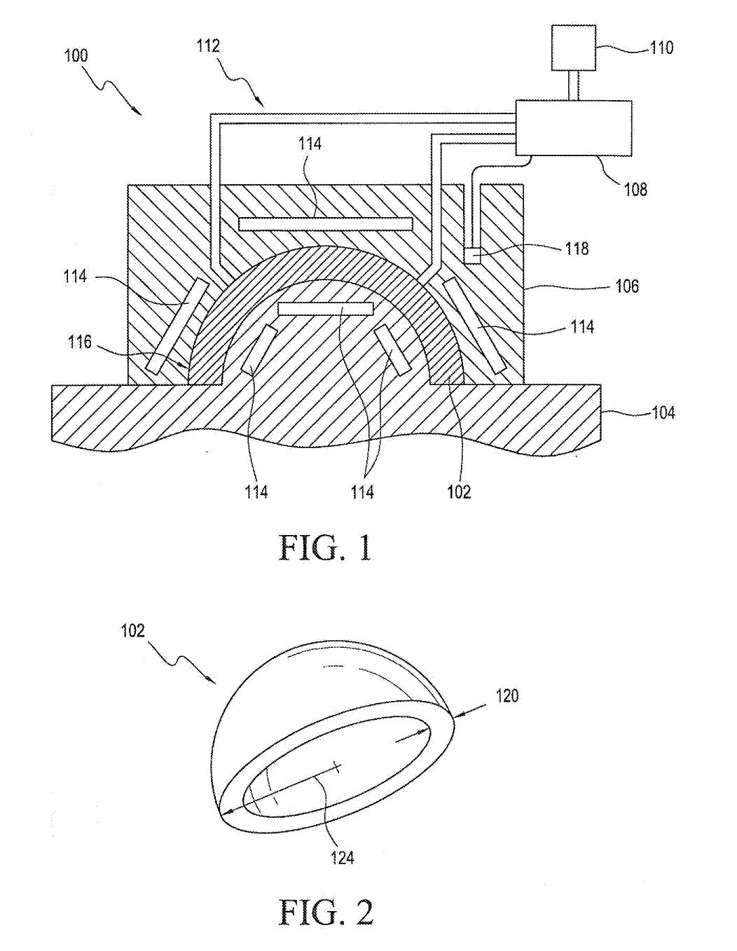

FIG. 1 shows a cross-sectional view of a processing apparatus in accordance with an exemplary embodiment of the present disclosure, indicated generally at 100. The function of processing apparatus 100 is to form a portion of a ball, which in an exemplary embodiment is a hemisphere, though some portions can be a portion of, for example, a prolate spheroid, oval, etc. In the embodiment of FIG. 1, the formed ball portion can be described as a blocker 102. Blocker 102 is fabricated with dimensions that are larger than the size of a finished ball. In an exemplary embodiment, blocker 102 is in the range 3% to 25% larger in thickness and outside dimension from a final dimension of a finished ball.

System 100 is configured to include a fixed, lower platform 102, a movable, upper platform 106, a fluid flow apparatus 108, which is supplied by a reservoir 110, a fluid delivery system 112, and a temperature control system 114.

To produce blocker 102, system 100 first lowers movable upper platform 106 to rest against fixed, lower platform 104, forming an enclosed cavity. Movable upper platform can be moved by a conventional system, such as a hydraulic system, a mechanical system, or an electrical system (not shown). Temperature control system 114 is operated to heat lower platform 104 and upper platform 106 prior to the introduction of a material in enclosed cavity 116. Temperature control system 114 can be a fluid flow system, resistive heaters, thermoelectric devices, and the like. Once the temperature of lower platform 104 and upper platform 106 reaches a predetermined temperature, as detected by a temperature sensor 118 that transmits signals to fluid flow apparatus 108, fluid flow apparatus 108 opens internal valves (not shown) to pump an expandable thermoplastic in the form of balls or pellets from reservoir 110 through fluid delivery system 112 into enclosed cavity 116. The heat generated by temperature control system 114 expands the thermoplastic in enclosed cavity 116, while causing the thermoplastic balls or pellets to bond with each other. The expansion of the thermoplastic occurs rapidly, after which temperature control system can be actuated or operated to provide cooling to lower platform 104 and upper platform 106 to solidify blocker 102 sufficiently to permit removal of blocker 102 from enclosed cavity 116.

In the context of this disclosure, the term fluid can apply to a liquid, or solids such as pellets that are configured to flow by mechanical force, by the flow of air, by gravity, etc. When the fluid comprises solid pellets, it can be advantageous to use an embodiment of processing apparatus 100 where the features of fixed, lower platform 104 are positioned in a movable, upper platform, and the features of movable, upper platform 106 are positioned in a fixed, lower platform.

As shown in FIG. 2, finished blocker 102 forms a portion of a ball, such as a hemisphere, a quarter section, etc., depending on the configuration of the respective ball. As formed, blocker 102 has a thickness 120 and an outside dimension or radius 122 that are in the range 3% to 25% larger than the regulation size of a finished ball. Finished blocker 102 is shown as being hollow in an interior portion. However, blocker 102 can be solid and still obtain all the features of the present disclosure.

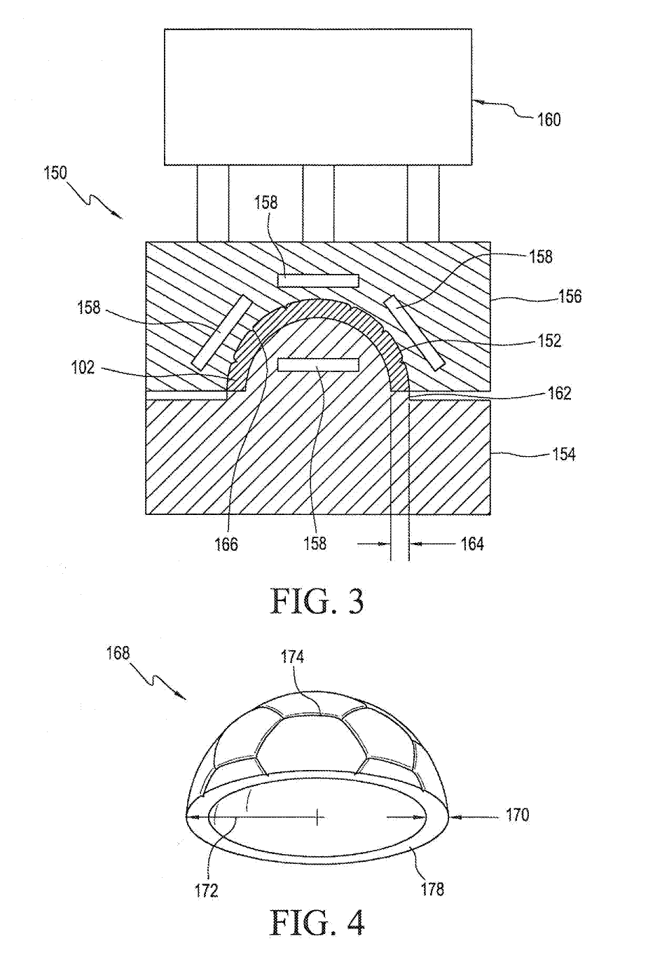

As shown in FIG. 3, blocker 102 is next positioned in a compression system 150, where blocker 102 is compressed to densify blocker 102 as well as configuring blocker 102 with regulation dimensions as modified for a laminated cover material, described further hereinbelow. Compression system 150 includes a compression cavity 152 configured to hold blocker 102, a fixed, lower platform 154, a movable, upper platform 156, a temperature control system 158, and a compression apparatus 160.

To transform blocker 102 into its final configuration, blocker 102 is positioned in compression cavity 152. Temperature control system 158 heats one or both of fixed, lower platform 154 and movable, upper platform 156 to raise the temperature of blocker 102, though the temperature is less than the melting temperature of the expanding thermoplastic. In an exemplary embodiment, the temperature of temperature control system 158 is set to be at least the flow temperature of the expanding thermoplastic, but less than the melting temperature, which allows densification and conformance of blocker 102 during a compression operation. After positioning blocker 102 in compression cavity 152, compression system 150 is actuated, causing movable, upper platform 156 to move toward fixed, lower platform 154.

It should be apparent that the positions of lower platform 154 and upper platform 156 can be reversed. In addition, upper platform 156 can be fixed while lower platform 154 is movable. The configuration and movement of platforms 154 and 156 are based on manufacturing considerations, as should be understood. In addition, alternative methods of compressing blocker 102 are possible. In an alternative embodiment (not shown), blocker 102 can travel through a heated chamber and be heated to soften the material of blocker 102 to allow thermal forming of blocker 102. Blocker 102 can then be positioned in a cold upper or lower mold and compressed to obtain final size, dimensions, and details.

Fixed lower platform 154 includes a step 162 having a width 164 that is approximately the same width of a finished ball. In an exemplary embodiment, movable, upper platform 156 is configured to include features 166, such as protrusions that form grooves in a ball, such as would be found, for example, in a soccer ball. The presence of step 162 permits movable, upper platform to move downwardly onto blocker 102, compressing blocker 102 into its final shape. Temperature control system 158 is configured to have sufficient heat mass that heating an individual blocker 102 occurs within a few seconds, providing fast and accurate compression of each individual blocker 102.

After a predetermined duration of time, or period, during which blocker 102 is rapidly cooled to fix the shape and dimensions of blocker 102, compression apparatus 160 lifts movable, upper platform 156, exposing blocker 102, which is now in its final shape and because it is in its final shape is described as a core 168, shown in FIG. 4. Core 168 has been densified by the compression operation such that thickness 170 and radius 172 to an outside surface of core 168 is in the appropriate range for the type of ball being produced. Depending on the type of ball being formed, core 168 can have features 174, which in the embodiment of FIG. 4 are grooves, such as those formed on a soccer ball. Such features can include a texture formed directly on core 168.

Though not shown, in an alternative embodiment, core 168 can be solid. The compression of a solid blocker yields a densified region that approximately corresponds to thickness 170. Thus, compression of a solid blocker yields an interior portion, region of volume with a first density, and a region adjacent to the exterior features 174 corresponding approximately to thickness 170 that has a second, higher density.

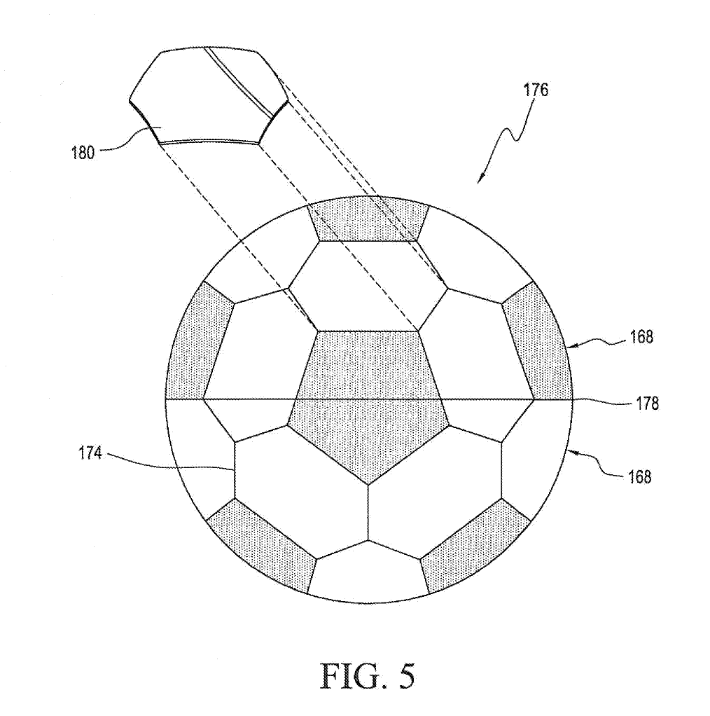

As shown in FIG. 5, a ball, such as a soccer ball 176, is formed by adhering a plurality of cores 168 to each other. In an exemplary embodiment, such adherence can be accomplished by spreading an adhesive over an interface surface 178 of each core 168, and then aligning cores 168 to each other. In another exemplary embodiment, interface surface 178 can be heated to provide flow or melting of interface surface, and two or more cores 168 can then be adhered to each other before the material of interface surface 178 solidifies. Once ball 176 is assembled, conventional decorative panels or plates 180 can be adhered to ball 176 to form a layer that includes a design, image, picture, etc.

As noted earlier, the dimensions of core 168 are set to a size that permits decorative plates 180 to be adhered thereto, yielding the final dimensions of a ball. In addition to providing the final exterior dimensions of a ball, decorative plates 180 are configured to provide a specific texture and feel to a particular ball. In an exemplary embodiment, decorative plates 180 are configured to be pebbled in a manner similar to a basketball. In another exemplary embodiment, decorative plates 180 are configured to be smooth with a micro-pattern in a manner similar to a soccer ball. In yet another exemplary embodiment, decorative plates 180 are configured to have an appearance and feel of leather, similar to a volley ball. Decorative plates 180 can be formed from an array of materials, including synthetic or natural leather.

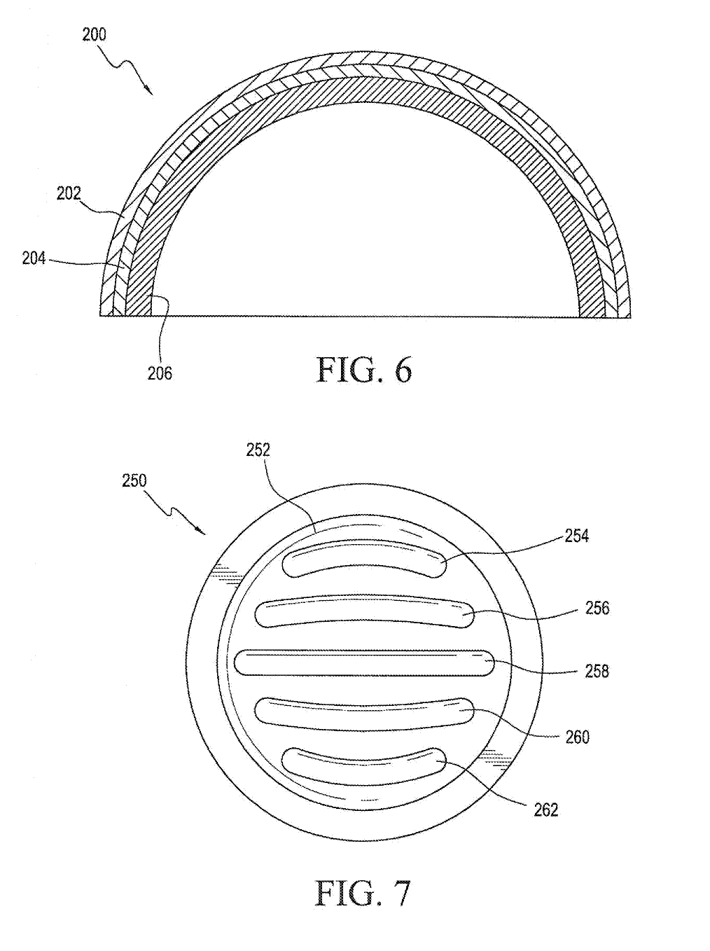

Another blocker in accordance with an exemplary embodiment of the present disclosure is shown in FIG. 6, and indicated generally at 200. Blocker 200 is configured to include a plurality of blocker layers 202, 204, and 206. Each blocker layer can be separately formed, adhered to each other, and then compressed, or, each blocker layer can be separately formed and compressed to form a core. The cores, which can each form half a ball, can then be adhered to each other in a manner similar to cores 168 to form a ball. Note that at least one outer or exterior surface, i.e., a surface away from an interior that may be hollow or away from a portion configured to be adhered to another blocker to form a ball, can include features formed during compression, such as grooves 174 shown in FIG. 5. Note that the portion configured to be adhered to another block to form a ball can be a flat or planar surface.

The advantage of blocker 200 is that the blocker layers 202, 204, and 206 allow the selection of performance features for blocker 200. It should be apparent that while three layers are shown, the number of layers can be as few as two, and more than three. Each layer provides a different characteristic. For example, in an exemplary embodiment layer 202 can be relatively soft and/or compliant compared to layer 204 and layer 206, allowing more contact time with a ball formed of blocker 200, and thus more control of the ball. In an exemplary embodiment, layer 202 can be less dense than layer 204 and layer 206, thus making layer 202 softer and/or more compliant. Layer 204 and layer 206 can be configured to provide resiliency to a ball to increase rebound speed. Such resiliency can be control by adding rubber elements to layer 204 and/or layer 206.

The sound of a ball can be adjusted by incorporating features into the interior of blockers. A blocker in accordance with an exemplary embodiment of the present disclosure and incorporating sound adjustment features is shown in FIG. 7 and indicated generally at 250. Blocker 250 is configured to include one or more interior features, such as slots or grooves 254, 256, 258, 260, and 262, formed in an interior surface 252 of blocker 250. After a ball is formed by adhering two or more blockers 250 together, each time the formed ball bounces, it will generate a sound that provides a characteristic of an inflated ball, or a unique characteristic if desired.

While various embodiments of the disclosure have been shown and described, it is understood that these embodiments are not limited thereto. The embodiments can be changed, modified, and further applied by those skilled in the art. Therefore, these embodiments are not limited to the details shown and described previously, but also include all such changes and modifications.

I/we claim:

1. A method of forming a ball, comprising:
forming a first blocker and a second blocker, each of the first blocker and the second blocker configured to have a first density;
heating each one the first blocker and the second blocker;
compressing each one of the heated first blocker and the heated second blocker in a compression mold to increase the density of each one of the heated first blocker and the heated second blocker to a second density greater than the first density; and
adhering the first blocker to the second blocker to form the ball.

2. The method of claim 1, further including adhering a plurality of decorative panels to an exterior surface of the ball.

3. The method of claim 2, wherein each one of the plurality of decorative panels is textured.

4. The method of claim 2, wherein the plurality of decorative panels includes one of a design, an image, and a picture.

5. The method of claim 1, wherein the each one of the first blocker and the second blocker is cooled after compressing and prior to release from the compression mold.

6. The method of claim 1, wherein each one of the first blocker and the second blocker includes a hollow interior portion formed by an interior surface.

7. The method of claim 6, wherein the interior surface includes features configured to modify the sound generated by the ball during a bounce.

8. The method of claim 1, wherein features are formed in an exterior surface of each one of the first blocker and the second blocker during compressing.

9. The method of claim 8, wherein the features include a plurality of grooves.

10. A method of forming a ball, comprising:
forming a first plurality of blockers, each blocker of the first plurality of blockers configured to have a first density;
heating each one the first plurality of blockers;
compressing each one of the first plurality of heated blockers to increase the density of each one of the first plurality of heated blockers to a second density greater than the first density; and
adhering each one of the first plurality of blockers to each other to form a first half of the ball.

11. The method of claim 8, further including:
forming a second plurality of blockers, each blocker of the second plurality of blockers configured to have a first density;
heating each one the second plurality of blockers;
compressing each one of the second plurality of heated blockers to increase the density of each one of the second plurality of heated blockers to a second density greater than the first density;
adhering each one of the second plurality of blockers to each other to form a second half of the ball; and
adhering the first half to the second half to form the ball.

12. The method of claim 11, further including adhering a plurality of decorative panels to an exterior surface of the ball.

13. The method of claim 12, wherein the plurality of decorative panels is textured.

14. The method of claim 12, wherein the plurality of decorative panels includes one of a design, an image, and a picture.

15. The method of claim 11, wherein the each one of first plurality of heated blockers and each one of the second plurality of heated blockers is cooled after compressing and prior to release from a compression mold.

16. The method of claim 11, wherein each one of the first half and the second half includes a hollow interior portion formed by an interior surface.

17. The method of claim 16, wherein the interior surface of at least one of the first half and the second half includes features configured to modify the sound generated by the ball during a bounce.

18. The method of claim 10, wherein each blocker of the first plurality of blockers has different performance characteristics from other blockers of the first plurality of blockers.

19. The method of claim 11, wherein features are formed in an exterior surface of at least one of the plurality of the plurality of first blockers and the plurality of second blockers during compressing.

20. The method of claim 19, wherein the features include a plurality of grooves.
